(19) United States
(12) Patent Application Publication
(10) Pub. No.: US 2026/0158301 A1
(43) Pub. Date: Jun. 11, 2026

(54) Full Face Hooded Respirator for Compatibility with Beards and Religious Head Coverings

(71) Applicant: WIN-SHIELD MEDICAL DEVICES INC., Winnipeg (CA)

(72) Inventors: Robert Ranson, Winnipeg (CA); Matthew Olson, Winnipeg (CA); Lionel Dueck, Winnipeg (CA); Jiang Xudong, Winnipeg (CA)

(21) Appl. No.: 19/104,062

(22) PCT Filed: Aug. 21, 2023
(86) PCT No.: PCT/CA2023/051102

§ 371 Date: Feb. 14, 2025

(30) Foreign Application Priority Data
Aug. 19, 2022 (CA) 3170758

(51) Int. Cl. A62B 17/04; A62B 17/00

(52) U.S. Cl. CPC A62B 17/04; A62B 17/001

(57) ABSTRACT

An inclusive full-face hooded respirator includes a novel neck seal and novel head harness enabling use of the respirator by the population at large, including bearded users and wearers of religious head coverings. The neck seal is an open ring that shares a zippered closure with an openable/closeable side of the hood, by which the seal is closeable around the neck at an elevation below a neck hairline of a bearded user, while the openable/closeable character of the hood enables careful donning thereof over religious head coverings in non-disruptive fashion. The head harness includes a widened top band to distribute loading of the headgear over a large surface area of the religious head covering, again in non-disruptive fashion thereto. A built-in cinching mechanism is provided to enable cinching of the hood into a more conforming size to the wearer's head or religious head covering.

### CROSS-REFERENCE TO RELATED APPLICATIONS

This application claims priority benefit of Canadian Patent Application No. 3,170,758, filed Aug. 19, 2022, the entirety of which is incorporated herein by reference.

### FIELD OF THE INVENTION

This application relates generally to the field of full-face respirators for providing a breathable air supply to a wearer, and more particularly to full-face hooded respirators that that include a wearable hood enveloping an entirety of the wearer's head, rather than the face alone.

### BACKGROUND

Full face respirators are used to provide personnel with a safely breathable air supply in environments known or suspected to potentially have harmful contaminants, or anywhere a natural ambient supply of breathable air may be unavailable or potentially jeopardized. Users of such respirators include military, law enforcement, firefighters, and personnel in various other sectors including oil & gas, pharmaceuticals, petrochemical/chemical, mining, metal fabrication, or other various industrial applications that may involve working in hazardous environments, and/or possible risk possible of exposure to chemical, biological, radiological and nuclear (CBRN) attacks. A conventional full-face respirator features a mask composed of a face shield embodying a transparent lens, a face seal spanning around a perimeter of the shield to form an outer seal around the eyes, nose and mouth of the wearer, and a nose cup on an inner surface of the shield within the bounds of the face seal to specifically fit over the nose and mouth of the wearer. Inhalation and exhalation ports and valves accompany the shield and nose cup to admit breathable air into the facial area bound by the face seal, and particularly into the nose cup to enable for inhalation of such breathable air, and to exhaust exhaled gases therefrom. Air supply conduits or filter cartridges are installed in co-operable relation to the inhalation ports to feed the breathable air from a connected air supply, or filter the ambient air to derive the breathable air therefrom. In some cases, for example in CBRN applications where skin exposure is also a concern, the full-face respirator may be a hooded respirator in which the mask is combined with a hood for covering the full head of the wearer.

A known shortcoming in this field of art is that conventional full-face respirators cannot achieve a proper fluid-tight facial seal with those who have facial hair, thus excluding use by bearded personnel, which specifically prohibits use by those for whom a beard is not merely an aesthetic choice, but rather a part of their religious practice or beliefs.

Additionally, conventional full-face respirators use a head harness composed of resiliently stretchable straps interconnected in a web-like fashion to wrap around the back of the wearer's head to hold the face seal snug against the wearer's face, which similarly renders such equipment unwearable by personnel who have religious head coverings (e.g. turbans) that are incompatible with such harnesses.

Accordingly, there remains a need for novel and inclusive full-face respirator solutions that can address these shortcomings of the prior art to enable use of such equipment among a wider breadth of the global population, regardless of religious affiliations and practices.

### SUMMARY OF THE INVENTION

According to a first aspect of the invention, there is provided a hooded full-face respirator comprising:
a mask assembly comprising:
   a shield for covering a face of a wearer at a facial area thereof that includes a nose, mouth and eyes of said wearer;
   a face seal spanning along an outer perimeter of the shield and projecting rearwardly therefrom for sealed placement against the face of the wearer in a position surrounding said facial area thereof;
   ports and associated valving accompanying the shield and the face seal, and positioned and operable to admit breathable air to the facial area of the wearer and exhaust exhaled gases therefrom;
a wearable hood of fluid-impermeable character and having a face opening in which the mask assembly is received, and around which the wearable hood has a fluid-tight attachment to the mask assembly around a full perimeter of the face-opening, and a neck opening in which a neck of the wearer is accommodated in a worn position of the respirator, and that is bordered by a neck margin of said wearable hood; and
a flexible neck seal comprising flexible impervious material and spanning about the neck opening, said neck seal having an inner wall bordering said neck opening for skin-abutting fluid-tight contact of an inner surface of said inner wall with the neck of the user in said worn position of the respirator; and an outer wall that is connected to the inner wall and situated outwardly of an outer surface thereof, and to which the neck margin of the wearable hood is sealed.

It will be appreciated that, except any instance explicitly indicating otherwise, “fluid” is used herein in its commonly understood meaning to encompass both gas and liquids.

According to a second aspect of the invention, there is provided a hooded full-face respirator comprising:
a mask assembly comprising:
   a shield for covering a face of a wearer at a facial area thereof that includes a nose, mouth and eyes of said wearer;
   a face seal spanning along an outer perimeter of the shield and projecting rearwardly therefrom for sealed placement against the face of the wearer in a position surrounding said facial area thereof;
   ports and associated valving accompanying the shield and the face seal, and positioned and operable to admit breathable air to the facial area of the wearer and exhaust exhaled gases therefrom;
a wearable hood of fluid-impermeable character and having a face opening in which the mask assembly is received, and around which the wearable hood has a fluid-tight attachment to the mask assembly around a full perimeter of the face-opening, and a neck opening in which a neck of the wearer is accommodated in a worn position of the respirator, and that is bordered by a neck margin of said wearable hood; and
a flexible neck seal comprising flexible impervious material and spanning about the neck opening, wherein the flexible neck seal forms an open-ring around the neck opening, said open ring having gap therein; and
a closure mechanism operable between an open position in which the gap in the neck seal is open to enable admission of the wearer's neck to the neck opening via said gap of the neck seal during said donning of the respirator, and a closed position closing said gap of the neck seal to achieve fluid-tightness thereof around the wearer's neck in the worn position of the respirator to prevent fluid from entering a resultingly enclosed and sealed headspace inside the hood.

According to a third aspect of the invention, there is provided a hooded full-face respirator comprising:
a mask assembly comprising:
   a shield for covering a face of a wearer at a facial area thereof that includes a nose, mouth and eyes of said wearer;
   a face seal spanning along an outer perimeter of the shield and projecting rearwardly therefrom for sealed placement against the face of the wearer in a position surrounding said facial area thereof;
   ports and associated valving accompanying the shield and the face seal, and positioned and operable to admit breathable air to the facial area of the wearer and exhaust exhaled gases therefrom;
   a multi-piece clamp composed of multiple clamping pieces clamping the face seal and the shield together around the perimeter of the shield; and
   an endless single-piece ring-shaped base frame that uninterruptedly spans a closed loop path around the multi-piece clamp and the face seal at an outer perimeter of the mask assembly; and
a wearable hood of fluid-impermeable character and having a face opening in which the mask assembly is received;
wherein a facial margin of the wearable hood borders and fully surrounds the face opening therein, and said facial margin of the wearable hood is sealed to the single-piece base frame of the mask assembly over a full and continuous span of the base frame's closed loop path around the multi-piece clamp and the face seal.

According to a fourth aspect of the invention, there is provided a hooded full-face respirator comprising:
a mask assembly comprising:
   a shield for covering a face of a wearer at a facial area thereof that includes a nose, mouth and eyes of said wearer;
   a face seal spanning along an outer perimeter of the shield and projecting rearwardly therefrom for sealed placement against the face of the wearer in a position surrounding said facial area thereof;
   ports and associated valving accompanying the shield and the face seal, and positioned and operable to admit breathable air to the facial area of the wearer and exhaust exhaled gases therefrom;
a wearable hood of fluid-impermeable character and having a face opening in which the mask assembly is received, and around which the wearable hood has a fluid-tight attachment to the mask assembly around a full perimeter of the face-opening, and a neck opening in which a neck of the wearer is accommodated in a worn position of the respirator, and that is bordered by a neck margin of said wearable hood; and
a flexible neck seal comprising flexible impervious material and spanning about the neck opening inside the neck margin of the hood;
wherein the hood comprises an outer neck flap spanning externally around the neck margin of the hood for receipt of an upper neck margin of an upper body shroud in a position encapsulated under the outer neck flap of the hood and spanning around the neck margin of the hood.

According to a fifth aspect of the invention, there is provided a full-face respirator comprising:
a mask assembly comprising:
   a shield for covering a face of a wearer at a facial area thereof that includes a nose, mouth and eyes of said wearer;
   a face seal spanning along an outer perimeter of the shield and projecting rearwardly therefrom for sealed placement against the face of the wearer in a position surrounding said facial area thereof;
   ports and associated valving accompanying the shield and the face seal, and positioned and operable to admit breathable air to the facial area of the wearer and exhaust exhaled gases therefrom; and
a head harness coupled to the mask assembly in a position spanning rearwardly therefrom to embrace posteriorly about a head of the wearer to secure the shield anteriorly of the face of the wearer;
wherein said head harness comprises a flexible upper component for connection to the mask assembly at upper securement points thereon, and a pair of flexible lower components for connection to the mask assembly at lower securement points thereon, wherein said flexible upper component includes a widened top band of greater width than each of said flexible lower components for draped donning of said widened top band over the head of the wearer or a religious head covering worn thereon.

According to a sixth aspect of the invention, there is provided a hooded full-face respirator comprising:
a mask assembly comprising:
   a shield for covering a face of a wearer at a facial area thereof that includes a nose, mouth and eyes of said wearer;
   a face seal spanning along an outer perimeter of the shield and projecting rearwardly therefrom for sealed placement against the face of the wearer in a position surrounding said facial area thereof;
   ports and associated valving accompanying the shield and the face seal, and positioned and operable to admit breathable air to the facial area of the wearer and exhaust exhaled gases therefrom;
a wearable hood of fluid-impermeable character and having a face opening in which the mask assembly is received, and around which the wearable hood has a fluid-tight attachment to the mask assembly around a full perimeter of the face-opening, and a neck opening in which a neck of the wearer is accommodated in a worn position of the respirator, and that is bordered by a neck margin of said wearable hood; and
a flexible neck seal comprising flexible impervious material and spanning about the neck opening inside the neck margin of the hood;
wherein the hood comprises a set of cinching members that are distributed over a surface area of the hood and are pullable to cinch the hood into a cinched state of more form-fitting character when worn on a head of the wearer.

According to a seventh aspect of the invention, there is provided a method for donning of a full-face respirator by a wearer, said method comprising:
(a) in possession of a full-face respirator that comprises a wearable hood with a face opening and a neck opening, a non-endless neck seal attached to the wearable hood around the neck opening therein and having an openable/closable gap, a face mask assembly received in a face opening of the wearable hood and sealed thereto, and a face seal and a head harness attached to said face shield, donning the face shield, the head harness and the wearable hood while the openable/closable gap of the neck seal is open;
(b) once the face shield, the head harness and the wearable hood have been donned to envelop the wearer's head and the head harness within the wearable hood, closing the openable/closable gap of the neck seal to fully close said neck seal around a neck of the wearer. This action prevents any fluids and/or gases from entering the closed hood, face seal, and face, mouth, nose and eyes.

According to an eighth aspect of the invention there is provided a full-face respirator comprising:
a mask assembly comprising:
   a shield for covering a face of a wearer at a facial area thereof that includes a nose, mouth and eyes said wearer;
   a face seal spanning along an outer perimeter of the shield and projecting rearwardly therefrom for sealed placement against the face of the wearer in a position surrounding said facial area thereof;
   ports and associated valving accompanying the shield and the face seal, and positioned and operable to admit breathable air to the facial area of the wearer and exhaust exhaled gases therefrom;
a head harness coupled to the mask assembly in a position spanning rearwardly therefrom to embrace posteriorly about a head of the wearer to secure the shield anteriorly of the face of the wearer; and
a tensioning mechanism at area portion of the head harness situated distally of the mask assembly and operable to tension one or more tensionable components of the head harness to pull the face seal snug against the face of the wearer.

### BRIEF DESCRIPTION OF THE DRAWINGS

Preferred embodiments of the invention will now be described in conjunction with the accompanying drawings in which:

FIG. 1 is an exploded perspective view of an inclusive full-face hooded respirator of the present invention.

FIG. 2 is an assembled side perspective view of the respirator of FIG. 1 from an openable and closable zippered side thereof.

FIG. 3 is an assembled side perspective view of the respirator of FIG. 1 from an opposing non-zippered side thereof.

FIG. 4 is a bottom plan view of the respirator of FIG. 1.

FIG. 5 is a cross-sectional view of the respirator of FIG. 4 as viewed along line A-A thereof.

FIG. 6 is an isolated perspective view of a neck seal of the respirator of FIG. 1.

FIG. 7 is an isolated rear perspective view of the respirator of FIG. 1 with the hood omitted to show interconnection of a head harness of the respirator with a mask assembly thereof inside the hood.

FIGS. 8 through 13 illustrate sequential steps in donning of the respirator of FIG. 1 by a wearer.

FIG. 14A is an assembled side elevational view of a variant of the respirator tin which the zipper has been relocated and anchored to the mask assembly, and in which a neck flap has been added and is shown in a hanging position thereof partially covering the zipper.

FIG. 14B is another side elevational view of the respirator of FIG. 14A in combination with an upper body shroud, and with the neck flap in a raised position for acceptance of the upper body shroud around a neck margin of the hood.

FIG. 14C is another side elevational view of the respirator and upper body shroud of FIG. 14B, with the upper body shroud coupled to the hood of the respirator.

FIG. 14D is another side elevational view of the respirator and coupled upper body shroud of FIG. 14C, but with the neck flap lowered back into its hanging position to achieve closure of the respirator and coupled upper body shroud around the neck of a wearer.

FIG. 15 is a side elevational view of another variant of the respirator in which a cinching mechanism is incorporated into the hood to enabling tightening thereof into a more conforming fit to the wearer's head or a religious head covering worn thereon.

### DETAILED DESCRIPTION

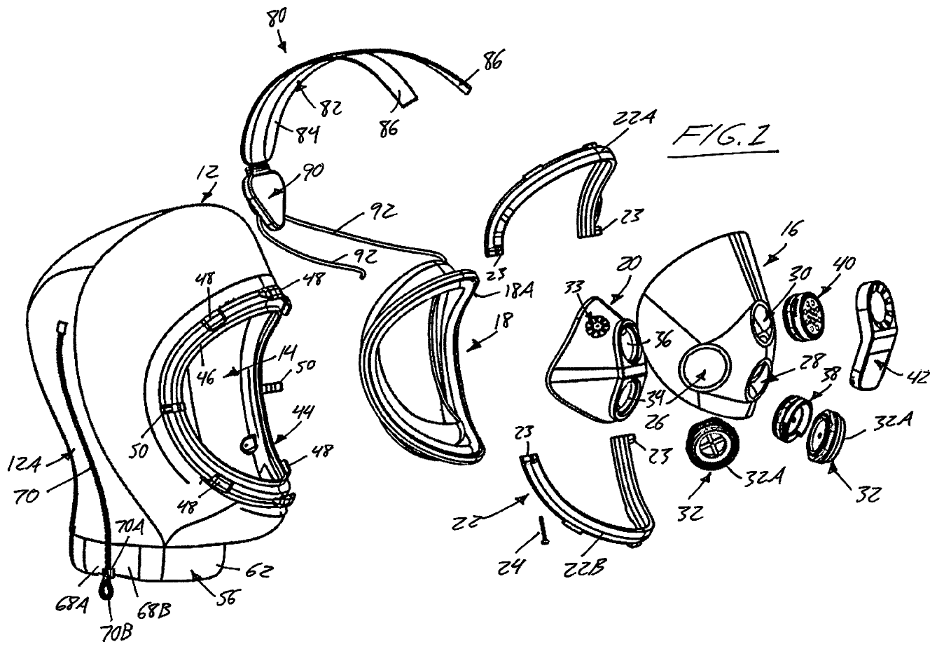

FIG. 1 shows an exploded view of an inclusive full-face hooded respirator 10 according to one embodiment of the present invention. The respirator 10 features a wearable hood 12 that is made of a flexible and fluid-impermeable material, and has a forward-facing face opening 14 at a front of the hood 12 and a downward facing neck opening 15 at a bottom of the hood. Installed in the face opening 14 of the hood 12 is a mask assembly that includes a rigid face shield 16 for covering a facial area of a wearer's face that includes the wearer's nose, mouth and eyes, a face seal 18 for spanning fully around an outer perimeter of the shield 16 in a position projecting rearwardly therefrom for sealed placement against the wearer's face around the aforementioned facial area, and a flexible nose cup 20 fitted against an inner surface of the face shield within the bounds of the face seal 18 to specifically fit over the nose and mouth of the aforementioned facial area of the wearer. If not an entirety of the face shield 16, then at least an upper portion thereof residing above the nose cup 20 is transparent to form a viewing lens of the mask assembly through which the wearer has an unobscured sight line.

The face seal 18 is a closed ring of resiliently flexible material having a profiled cross-section that includes an in-turned front lip 18A of S-shaped profile that embraces an outer edge of the face shield 16 around a full perimeter thereof in fluid-tight sealed relation therewith. The S-shaped profile of the front lip 18A is best seen in the cross-sectional view of FIG. 5, where a terminal end of this S-shaped lip turns inwardly over the exterior surface of the face shield 16 at outer margin thereof. To hold the shield 16 and face seal 18 together in this sealed relationship at the shield's outer perimeter, the mask assembly also includes a two-piece clamp 22, composed of an upper clamp member 22A and a lower clamp member 22B, each shaped to span a respective half of the shield's outer perimeter and a respective half of the face seal's closed-ring shape. In an installed position of the clamp 22, each clamp member 22A, 22B embraces over a front side of the front lip 18A of the face seal 18 at an exterior side of the shield 16 (i.e. the side thereof facing away from the wearer's face, and oppositely of the aforementioned cup-receiving inner surface of the shield). The two clamp members 22A, 22B are generally U-shaped to each overlie the front lip 18A of a respective half of the closed-ring face seal 18. The two free ends of each clamp member 22A, 22B feature respective fastening lugs 23, so that in the installed position of the two-piece clamp 22, the two fastening lugs 23 of each clamp member 22A, 22B align with those of the other clamp member for securement of these lugs 23 together in aligned pairs by two fasteners (one of which is shown at 24), as described in more detail below.

At a lower portion of the shield 16 where the nose cup 20 is received in abutting and sealed relationship against the shield's inner surface, the shield 16 features two inhalation ports 26 at laterally and symmetrically offset positions from a vertically bisecting midplane of the shield. An exhalation port 28 and a speech port 30 are instead centered on the shield 16 at the bisecting midplane thereof, with the speech port 30 in spaced elevation above the exhalation port 28.

Each inhalation port 26 has a respective inhalation valve assembly 32 installed therein, which includes a one-way valve through air is admissible to the facial area of the wearer, but through which flow is prohibited in an opposing direction of exhausting relationship to said facial area. An outer end 32A of each inhalation valve assembly at the exterior side of the shield is configured as a connector for selective connection of a cartridge filter or air supply conduit thereto. This may be, for example, a threaded connector (e.g. with 40 mm NATO threading) or a bayonet style connector. Instead of direct coupling of a filter cartridge or air supply conduit of directly compatible coupling type, indirect coupling via an adapter may be used where the respirator's coupler type doesn't match that of a particular filter cartridge or air supply conduit. The nose cup 20 has inhalation apertures 33 therein on both sides thereof, where the nose cup is fitted with one-way valves allowing airflow into the nose cup, but not outwardly therefrom, whereby breathable air admitted into the larger overall facial area by the inhalation valve assemblies 32 is further admissible into the nose cup 20 via these inhalation apertures 33 and associated one-way valves. When connected to the inhalation valve assemblies 32 in the inhalation ports, the air supply conduits or filter cartridges (not shown) can therefore feed breathable air from a connected air supply into the mask assembly for inhalation by the wearer, or filter the ambient air outside the mask to derive the breathable air therefrom for safe inhalation by the wearer.

Exhalation port 28 and speech port 30 of the shield 16 respectively align and communicate with exhalation and speech apertures 34, 36 that penetrate the front end of the nose cup 20, where the nose cup 20 fits up against the inner surface of the shield. The exhalation port 28 has an exhalation valve assembly 38 installed therein, which includes a one-way valve through which exhaled gases are exhaustible from the nose cup covered region of the facial area to the ambient environment outside the mask, but that prohibits airflow in the reverse direction into the nose cup 20 and facial area. The speech port 30 has a speech diaphragm 40 installed therein through which the wearer can verbally communicate to other personnel through the mask, without sacrificing the airflow control functions imparted by the inhalation and exhalation valves. As shown, the mask assembly may also include a front cover 42 that fits over the exhalation valve assembly 38 and speech diaphragm 40 and the associated ports of the face shield 16.

In addition to the rigid shield 16, flexible nose cup 20, flexible face seal 18, and the rigid clamp members 22A, 22B, the mask assembly further includes a rigid base frame 44 that serves as an interface by which a fully sealed relationship is achievable between the mask assembly and the hood 12. Unlike the two-piece clamp 22, the base frame 44 is a singular, unitary body of closed-ring shape that uninterruptedly spans a closed loop path around the multi-piece clamp 22 and the face seal 18 at an outermost perimeter of the mask assembly. At a front side of the base frame 44 (the side thereof that faces away from the face of the wearer), an inner margin of the base frame 44 nearest to the central opening bound by its closed-ring shape is rearwardly recessed or inset from the from the surrounding surface of the base frame's front side. This inset marginal recess 46 of the base frame receives the front lip 18A of the face seal 18 in the assembled state of the mask assembly, as best seen in the cross-sectional view of FIG. 5. The front side of the base frame 44 also features a set of holding tabs 48 that are situated at spaced intervals around the closed-ring shape of the base frame 44, and that overhang the inset marginal recess 46 from the non-recessed surrounding surface of the base frame's front side. The front side of the base frame 44 also features a pair of mounting lugs 50 likewise protruding from the non-recessed surrounding area around the inset marginal recess 46 at diametrically and horizontally opposing points from one another across the opening the base frame's closed-ring shape.

Each mounting lug 50 is received between an aligned pair of the fastening lugs 23 on the two-piece clamp 22, and the fastening lugs 23 of the clamp members 22A, 22B are fastened together through the mounting lugs 50 of the base frame 44 using the aforementioned fasteners 44, whereby this fastened connection between the upper clamp member 22A and lower clamp member 22B also fastens the assembled two-piece clamp 22 to the base frame 44, specifically in a position where the holding tabs 48 of the base frame also overlap the outer perimeter of the assembled two-piece clamp 22 to hold the two-piece clamp 22 and front lip 18A of the face seal 18 snugly and sealingly against the inset marginal recess 46 of the base frame 44. The front lip 18A of the face seal that embraces the perimeter edge of the face shield 16 is thus sandwiched in place and compressed between the two-piece clamp 22 and the exterior surface of the face shield 16, and also between the inset marginal recess 46 of the base frame 44 and the inner surface of the face shield, thus ensuring a fluid-tight seal around between the face shield 16 and the face seal 18 around an entirety of the face shield's outer perimeter.

Referring to FIG. 5, from where the S-shaped front lip 18A wraps around the free edge of the inset marginal recess 46, the face seal 18 continues rearwardly through the opening of the base frame 44 to reach therebehind in order to make contact with the wearer's face. At an upper portion of the face seal 18, the S-shaped profile of the front lip 18A joins with a V-shaped upper profile 18B that first radiates outwardly away from the opening of the base frame 44, and then turns back inwardly toward the opening of the base frame again. It is this back-turned second leg of the V-shaped profile 18B that makes contact with the wearer's face (and particularly the forehead in the case of the vertical cross-section shown in FIG. 5). A lower portion of the face seal 18 has a more complex profile for better conformance to the rounded chin of the wearer, as opposed to the wearer's relatively flat forehead that is abutted by the V-shaped upper profile 18B. At the lower portion of the face seal, the S-shaped profile of the front lip 18A instead joins with a narrow U-shaped lower profile 18C that first projects rearwardly through the opening of the base frame 44, then reverses direction back toward the opening of the base frame 44 through a roughly 180-degree transitional curve. After this U-shaped lower profile 18C, the cross-section shape of the lower portion of the face seal then terminates with a back-curved tail 18D turning radially inwardly of the base frame's opening, and slightly rearwardly therefrom. This creates a concave chain cradle 54 in a lower backside of the face seal 18 for mating with the chin of the wearer. Moving upwardly from the lowermost point of the face seal 18 at the bisecting midplane of the mask, the cross-sectional shape of the face seal gradually transitions between the described lower chin-level profile and the upper forehead-level profile to generally conform with the jaw and cheeks of the wearer along the way.

The unitary structure and closed-ring shape of the base frame 44 provides a continuous, unitary, seamlessly integral structure around an entirety of the mask assembly, to which the impermeable wearable hood 12 can be bonded in fluid-tight attachment thereto over a full and continuous span of the base frame's closed-loop path around the outside of the shield 16, face seal 18, and two-piece clamp 22, thereby ensuring a fully intact fluid-tight seal between a facial margin of the hood 12 (i.e. the area thereof immediately bordering the face opening 14) and the mask assembly around an entirety thereof.

As outlined in the background above, a particular problem that remains unaddressed in the field of full-face respirators is the incompatibility thereof with bearded users, given that the presence of facial hair makes it impossible to achieve 100% sealed relationship between the face seal 18 and the beard-covered skin of the wearer's face. To address this, the lower neck margin of the wearable hood 12, referring to the area thereof immediately bordering the neck opening 15 at the hood's bottom end, is equipped with a novel neck seal 56 designed to provide fluid-tight skin contact with the wearer's neck at an elevation thereof below the hairline of the wearer's beard. The mask assembly still includes a face seal 18 for cushioned seating of the mask assembly against the wearer's face, and with as much fluid-tight skin contact as possible, regardless of whether the wearer might be bearded or not, to try and best achieve a direct sealing of the facial area containing the eyes, mouth and nose of the wearer. On top of this, the aforementioned full-perimeter sealing of the hood's face opening 14 to a rigid, continuous, closed-loop, single-piece base frame 44 and the novel neck seal 56 are employed to cooperatively seal off an entirety of hood interior from the outside environment, regardless of the incomplete or incomplete facial seal accomplished, depending on the wearer's bearded or non-bearded status.

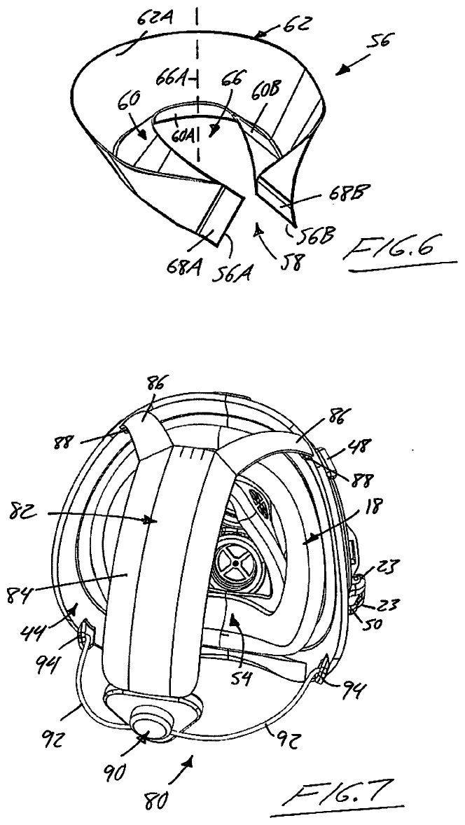

The neck seal 56 of the illustrated embodiment is a singular unitary body made of flexible and impervious material of different composition that than the fluid impermeable composition of the hood 12 itself, which may employ an at least partly fabric construction, whereas the neck seal will typically be of a polymeric composition. Though the purpose of the neck seal 56 during use of the respirator 10 is to form a fully closed seal spanning an entirety of the wearer's neck circumference, the neck seal 56 itself does not form a self-closed ring therearound, and instead is itself an open-ring having an openable and closable gap 58 therein, as best illustrated by the isolated view of the neck seal 56 in FIG. 6. The neck seal has a multi-walled structure comprising at least an inner wall 60 for making fluid-tight skin contact with the wearer's neck, and an outer wall 62 that provides a separate interface for sealed attachment of the neck seal 56 to the fabric of the hood 12, whereby this interface does not coincide with the same inner wall 60 that makes the skin-abutting fluid-tight contact with the wearer's neck, at least over a majority of the neck seal's circumferential span therearound. This way, movement of the wearer's neck has less impact on the critically sealed attachment between the hood 12 and the neck seal 56 in order to best maintain the fluid-tight integrity of the hood interior, especially when the respirator is used by bearded personnel who cannot achieve a fully sealed status at the face seal 18 given their bearded status.

In the illustrated example, the neck seal is J-shaped in cross-sectional profile, meaning that one of the inner and outer walls (the inner wall, in the illustrated example) is shorter than the other, and two walls are joined together only via a singular transitional bend or curve 64. The same single-transition character would be shared in the alternative possibility of a U-shaped or V-shaped neck seal profile, where the two walls would instead have the same height. While the illustrated example shows the single-transition J-shaped profile as being oriented open-side-up, where the inner and outer walls 60, 62 are joined together at their bottom ends by the singular transition 64, resulting in trough-like appearance, this arrangement could be inverted into an open-side-down (inverted-trough) orientation with the singular transition 64 at the top. Other profile options likewise capable of using an inner wall for the neck-sealing contact and an outer wall for the hood attachment interface could have one or more intermediate walls between the inner and outer walls, for example an N-shaped profile with a singular intermediate wall joined to the inner and outer walls by two respective transitional bends or curves, or a W-shaped profile with two intermediate walls, and three total transitional bends or curves completing the connections between the multiple walls. Such alternatives may be characterized as pleated or accordion-like profiles.

The open-ring character of the neck seal 56 means that it has two terminal ends 56A, 56B, each of which neighbours the openable/closable gap 58 of the neck seal's open-ring shape. The open-ring shape of the neck seal 56 spans around a central opening 66 bound by the neck seal's inner wall 60. In terms of the relative angular spans of the inner and outer walls 60, 62 around this central opening 66, the inner wall 60 spans a slightly further around this central opening 66 than the outer wall 62, whereby the two terminal ends 56A, 56B of the neck seal are defined solely by the inner wall 60 thereof. In contrast, the outer wall 62 terminates short of each of the neck seal's terminal ends 56A, 56B, and instead merges with the inner wall 60 at a short offset distance from each terminal end 56A, 56B of the neck seal 56.

The result is that the neck seal 56 has a multi-walled cross-sectional profile over most of its open-ringed shape, but is only single-walled at its end-adjacent extremities in order to effectively form end tabs 68A, 68B that can be fastened together by a suitable closure mechanism in order to fully close the neck seal 56 around the wearer's neck. Multi-walled is used here to mean discernable walls distinctly recognizable by the presence of open space between the facing-together surfaces of two adjacent walls (i.e. the outer surface 60B of the inner wall 60, and inner surface 62A of the outer wall 62, in the illustrated two-wall example). The “single-walled” character at the end tabs 68A, 68B need not necessarily mean that these tabs share the same thickness as the discernable inner wall 60 of the multi-walled majority of the seal. Alternatively, the merging of the inner and outer walls may result in a thicker single wall at the end tabs 68A, 68B of the neck seal. In the illustrated embodiment, the inner wall is not parallel to a central axis 66A of the central opening 66, and instead resides an oblique angle thereto such that an inner diameter of the neck seal 56 is tapered, rather than uniform, over the axial height of the neck seal. This internally tapered configuration of the neck seal, with its obliquely angled inner wall 60, better conforms to variations in the skin topography of the wearer's neck (owing to musculature or other topographical variations in neck shape) to ensure a full circumferential seal fully therearound with no air gaps.

In the illustrated embodiment, this closure mechanism for completing the closure of the open-ring neck seal 56 around the wearer's neck is a shared closure mechanism embodied by a fluid-tight zipper 70 that is also operable to selectively open and close the wearable hood 12 on an openable and closable side 12A thereof at which the gap 58 of the open-ring neck seal 12 also resides. The lower neck margin of the hood is bonded in fluid-tight relationship to the outer wall 62 of the neck seal 56 over a full and continuous length of the outer wall's angular span around the neck opening 15 of the hood. In the illustrated embodiment, where the closure mechanism is a zipper 70 operable to secure the two ends tabs 68A, 68B of the neck seal 56 together in end-to-end non-overlapping relation to one another closing the neck seal's open-ring gap 58, the lower neck margin of hood 12 is also bonded in fluid-tight relationship to the end tabs 68A, 68B of the neck seal 56, whereby the fluid-tight attachment of the hood's lower neck margin to the neck seal 56 actually spans the entire end-to-end circumferential length of the neck seal 56.

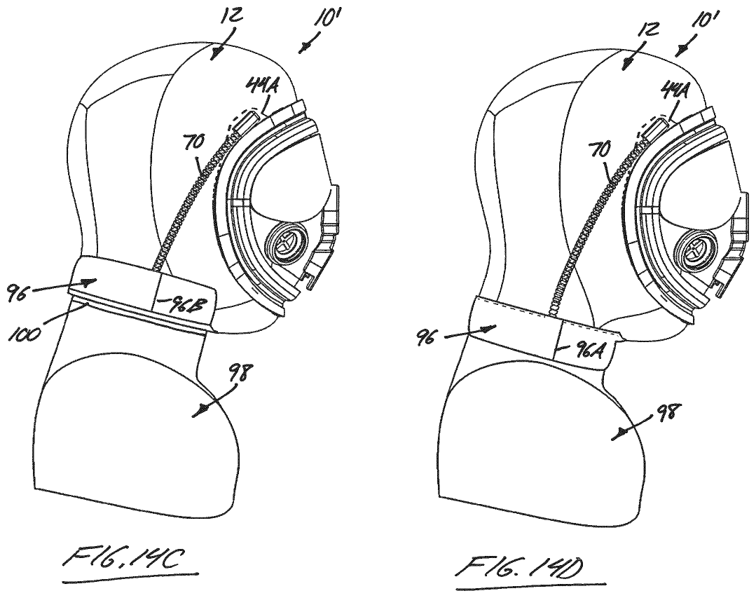

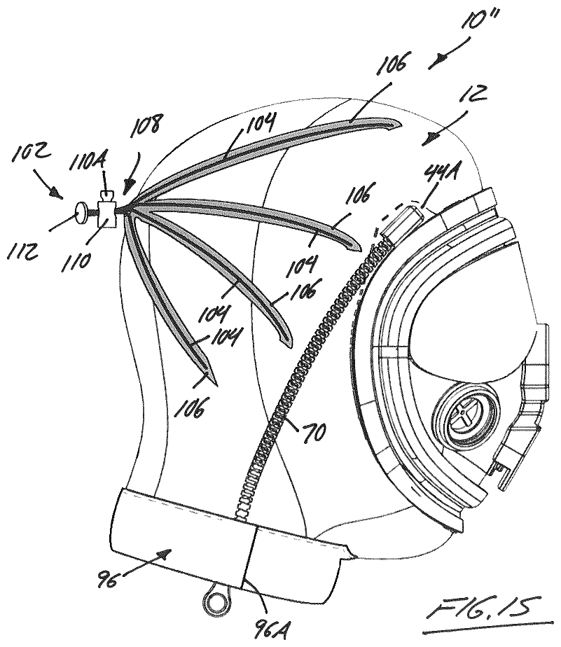

The openable/closable side 12A of the hood 12 in the illustrated embodiment is a lateral side thereof of non-opposing relationship to the face-opening 14 and the mask assembly installed therein at the front of the hood, as opposed to being a rear or posterior side of the hood that resides directly opposite the face opening 14 and mask assembly. That being said, opening/closing of the hood's rear or posterior side is a viable alternative that is also within the scope of the present invention. In the illustrated embodiment, where the neck seal 56 and hood share the same zipper-based closure mechanism, the gap 58 of the open-ring neck seal 56 thus likewise resides at a lateral side of the hood 12. This is believed to provide easier and more comfortable access to the zipper 70 than a rear/posterior placement thereof. As demonstrated by an illustrated variant of the respirator 10′shown FIGS. 14A-14D, the zipper 70 may be moved closer to the face opening 14 of the hood than illustrated in the earlier figures in order to reside more closely adjacent to the rigid base frame 44 of the mask assembly. In such case, the base frame 44 (or another rigid component of the mask assembly, or at least a component thereof of greater rigidity and tear strength than the hood material) may incorporate a bumped out anchor tab 44A thereon to which the top ends of the zipper panels may be attached, thus anchoring the zipper 70 to the rigid structure of the base frame 44. This way, pulling forces exerted on the zipper 70 during use thereof are not borne entirely by the constituent material (e.g. fabric) of the hood 12 and its sealed attachment to the rigid frame, thus reducing the likelihood of potential failure of the hood material or its sealed attachment to the mask assembly. The zipper and bumped out anchor tab may be located on either one of the left or right side of the device.

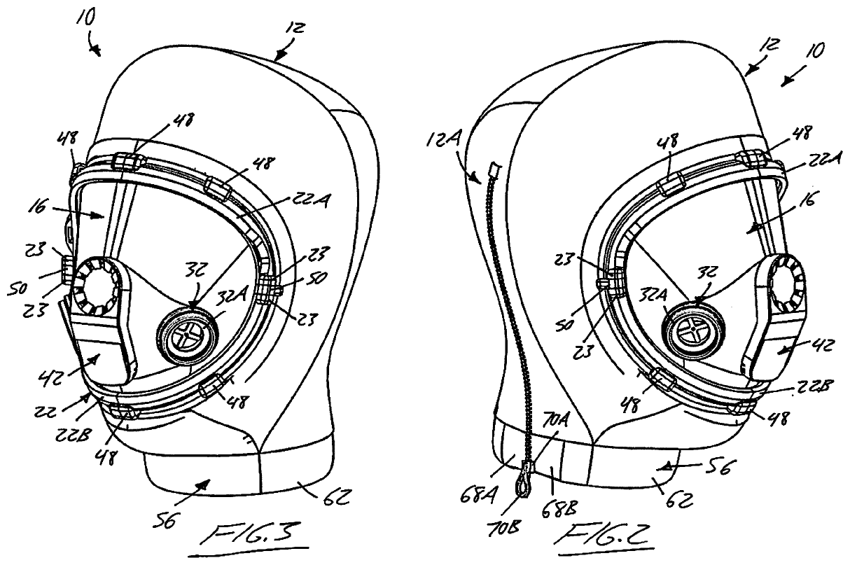

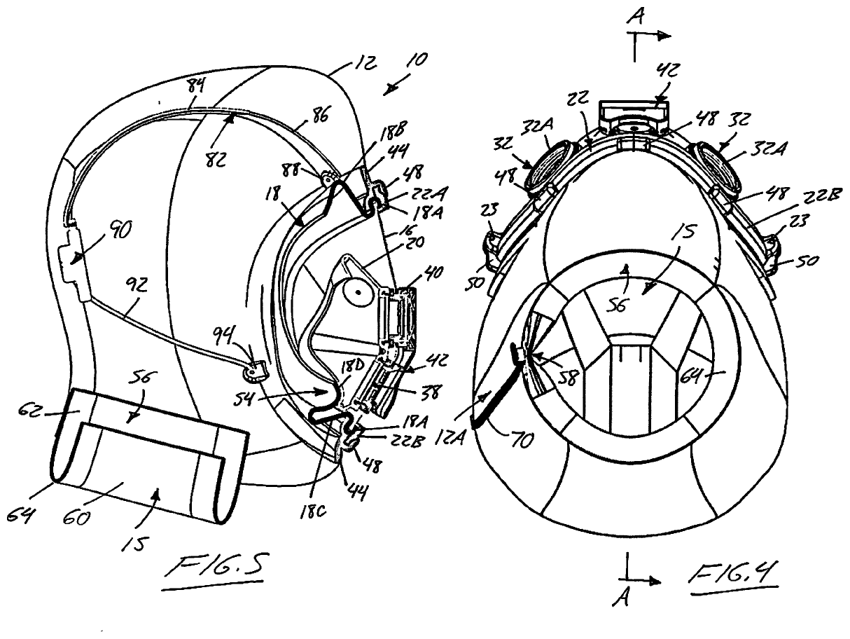

FIGS. 1, 2 and 4 show the zipper 70 in a closed position that both closes off both a slitted zipper opening in the hood 12 at the openable/closable side 12A thereof, and also closes off the openable/closable gap 58 of the open-ring neck seal 56, thereby closing off the interior of the hood in fluid tight fashion, and securing the neck seal 56 in a fully closed position around the wearer's neck to achieve fluid-tight relationship between the skin of the wearer's neck and the inner surface 60A of the inside wall 60 of the neck seal around the full circumference of the wearer's neck. In this closed position, the zipper's slider body 70A and pull tab 70B reside at the bottom end of the zipper's travel path at the bottom of the end tabs 68A, 68B of the neck seal 56. To open the hood and neck seal, the slider body 70A is pulled upward via its pull tab 70B in an opening stroke drawing the slider body up to a top end of its travel path, at an elevation closer to the top of the of the mask assembly's base frame 44, proximate to which the zipper panels may be anchored to said base frame 44 of the mask assembly, as contemplated above and shown in FIG. 14.

While the illustrated embodiment employs zippered closure of the neck seal, and sharing of that zippered closure by the openable/closable side 12A of the hood 12, other embodiments may employ other types of neck seal closure (e.g. fluid-tight snap closure at overlapping end tabs of the neck seal 56), whether in a shared or unshared relation to the preferred (though not always mandatory) inclusion of an openable/closable side of the hood, whether zippered, or other fastened in a fluid-tight manner when closed.

The illustrated embodiment of the full-face hooded respirator 10 also includes a novel head harness 80 for supporting the mask assembly and holding the face seal 18 thereof snug against the face of the wearer, and doing so in a manner that beneficially accommodates a religious head covering (e.g. turban), but is also usable by personnel lacking any such religious head covering. The harness features a flexible upper component 82 composed of a wide top band 84 for draped placement overtop of the religious head covering during donning of the respirator, and a pair of narrower top straps 86 diverging forwardly from a front end of the wide top band 84 and connected to a pair of upper securement tabs 88 included on the mask assembly's base frame 44 at an upper segment thereof. Connection of the front end of one of the top straps 86 to one such harness tab 88 on the base frame 44 of the mask assembly is shown in the cross-sectional view of FIG. 5.

Attached to the upper component 82 at a lower rear end of the wide band 84 thereof is a tensioning mechanism 90 that, in the worn position of the respirator 10, resides posteriorly of the wearer's head at a generally centered position at a median plane of the wearer's anatomy. This posterior positioning of the tensioning mechanism is particularly appreciable from FIG. 5, where the tensioning mechanism 90 can be seen to reside at the rear of the hood's interior space. A pair of flexible and tensionable lower components 92 span forwardly from the tensioning mechanism 90 on opposing sides of the wearer's head or neck, and are connected to a pair of lower securement tabs 94 found on opposing sides of a lower segment of the mask assembly's base frame 44. One such connection to a lower securement tab 94 is also visible in FIG. 5.

The tensioning mechanism 90 has a manually rotatable actuator for tensioning the tensionable lower components 92, which owing to the posterior placement of the tensioning mechanism in distal opposition to the anteriorly worn mask assembly, pulls the mask assembly rearward, thus abutting the face seal 18 snugly against wearer's face. The tensioning mechanism 90 exerts no tensioning action on the upper component 82 however. The relatively wide band 84 of the non-tensioned upper component 82 laid overtop of the wearer's religious head covering distributes any loading evenly across a large surface area thereof so as not to cause any disruption thereto, while cooperating with the narrower tensioned lower components 92 to properly hold the mask assembly in place. One non-limiting example of a prior art tensioning mechanism with a rotatable actuator operable in the described manner to tension the tensionable lower components, and also having a release function to relax the tensioned state thereof when it's time to remove the respirator, can be seen in U.S. Pat. No. 5,157,813, issued Oct. 27, 1992, to inventor William Carroll, the entirety of which is incorporated herein by reference.

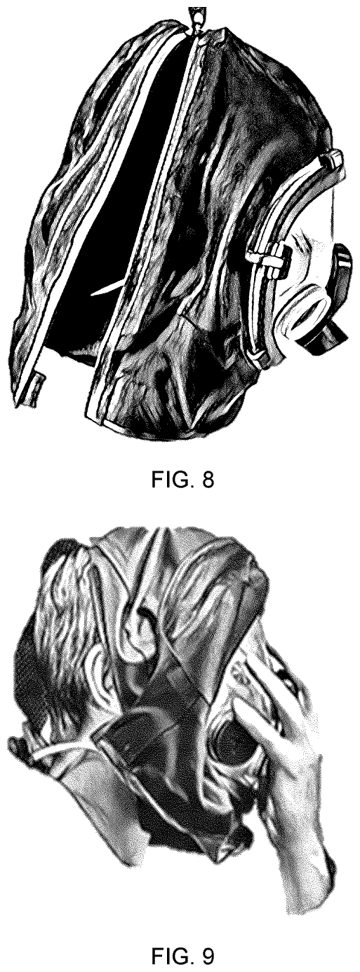

Having described the physical componentry of the respirator 10, attention is now turned to how the respirator is donned by the wearer, with sequential reference to FIGS. 8 through 14. Starting at FIG. 8, if the zipper 70 is not already unzipped to open up both the side 12A of the hood and the neck seal 56, the donning procedure starts with such an unzipping, or similar opening of an alternative closure type if used instead of the illustrated zipper 70. With the side 12A of the hood 12 opened up, the hood can be drawn forwardly toward the mask assembly to expose more of the head harness, particularly to access the tensioning mechanism 90 thereof, whose release function is then actuated to allow drawing out of the lower tensioning members 92 further therefrom to a more slackened length enabling donning of the head harness, if not already sufficiently slackened. With the head harness suitably slackened and the mask assembly held in front of the intended wearer's face, the upper component 82 of the head harness is laid overtop of the head of the intended wearer, and overtop of any religious head covering worn thereby, to place the rear portion of the head harness, and thus the tensioning mechanism 90, behind the intended wearer's head, as shown in FIG. 9. Meanwhile, the shield 16 is suitably aligned with the face so that the top apex of the nose cup 20 aligns with bridge of the intended wearer's nose, and the mask assembly is urged toward the intended wearer's face to make contact of the face seal 18 therewith, particularly ensuring receipt of the intended wearer's chin specifically in the chin cradle 54 of the face seal 18.

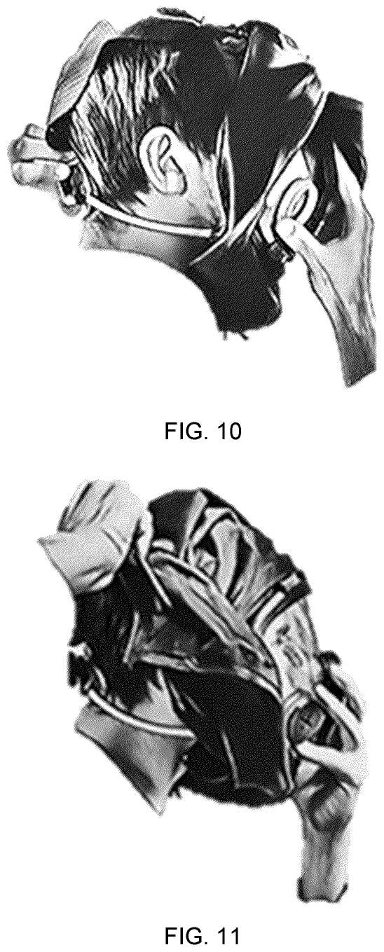

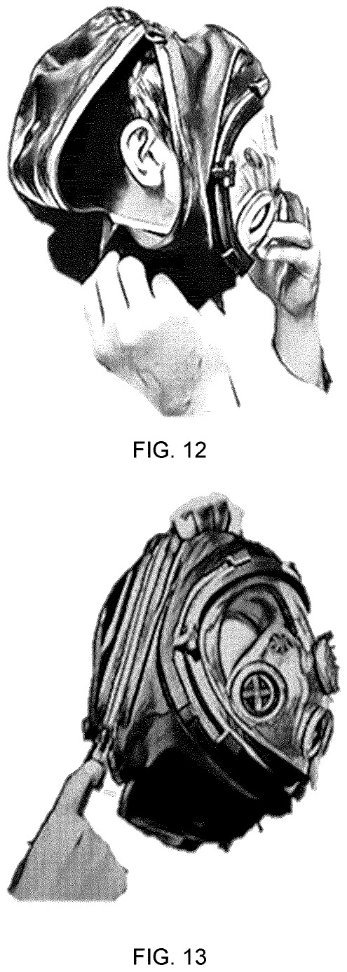

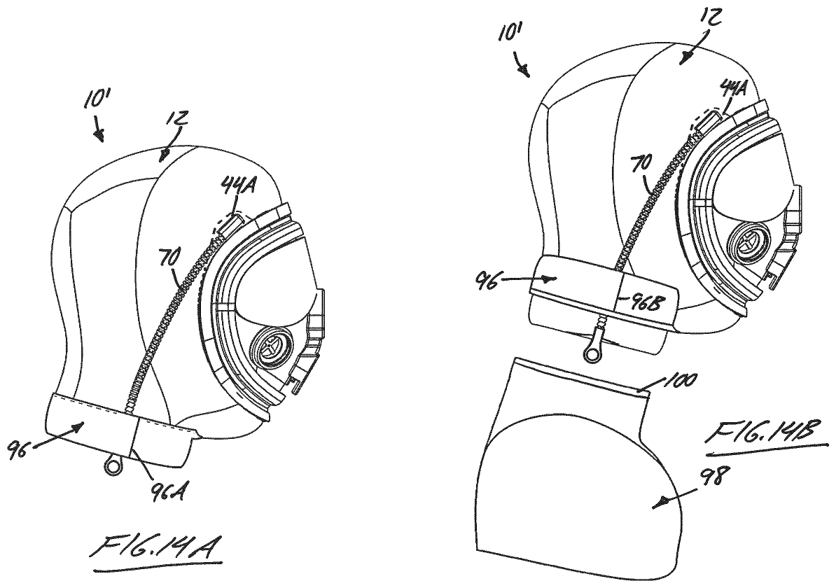

Next, at FIG. 10, the tensioning mechanism 90 behind the intended wearer's head is actuated to tension the previously slackened tensionable components 92 of the head harness, thereby pulling the face seal 18 snug against the face of the wearer, and over any beard possibly worn thereby, thereby completing the donning of the mask assembly. Next, at FIG. 11, the forwardly drawn hood is now pulled rearwardly into enveloping relationship over and around the head harness and the wearer's head (and any religious head covering thereon), during which the two sides of the zippered slit in the openable/closable side of the hood are brought together to enable zippered closure thereof. Next, at FIG. 12, the two ends of the open-ring neck seal 56 are drawn together at the bottom of the zippered slit of the hood 12 to close the circumferential span of the neck seal 56 fully around the wearer's neck. Finally, at FIG. 13, the zipper 70 is pulled down into its closed position, thereby both closing off the side 12A of the hood and fastening the two ends of the neck seal 56 together to fully close the neck seal gap 58 and thereby secure the neck seal 56 in a closed fluid-tight relationship around the wearer's full neck circumference.

It will be appreciated that instead of the novel tensioner-equipped harness described above, the head harness may alternatively omit the two cord-shaped lower components 92 of the illustrated example, and the associated tensioner 90, and replace these cord-shaped components 92 with a pair of length-adjustable lower straps, similar to the top straps 86, which may likewise be length-adjustable in similar fashion to conventional head harnesses for full-face respirators, while retaining the novel inclusion of a widened top band 84 whose width, measured laterally of the wearer, exceeds the individual widths of the top straps 86 that diverge from the top band's front end, and also exceeds the individual widths of the lower components 92, whether these be tensionable cords or length-adjustable straps, for the functional benefit described above in relation to religious head coverings. In other cases, the head harness 80 can be of entirely conventional design, without detraction from other novel and inventive aspects of the present invention, such as the novel combination of an openable/closeable respirator hood with an openable/closeable neck seal to accommodate bearded users. Likewise, this and other novel and inventive aspects of the hood and neck seal design can be put to beneficial use regardless of the particular details of the mask assembly and its coupling to the hood. For example, in one contemplated alternative, instead of clamped attachment of the face shield to the frame, the face shield may instead be bonded to the base frame. Optionally, in accompaniment to such omission of the clamping pieces, the inclusion of a hard plastic base frame may also be omitted in favour of a rubber or similar perimeter member of the shield to which to the lens and hood are both bonded, and which integrally incorporates the face seal.

In addition to the repositioning of the zipper and the anchoring of the fixed upper end of the zipper to a rigid base or other component of the mask assembly, rather than to the hood alone, FIG. 14A also illustrates optional inclusion of an outer neck flap 96 on the hood 12 in a position hanging over and spanning around the lower neck margin of the hood 12 in external relation thereto. An upper margin of this neck flap 96 is attached to the hood 12 over a nearly full circumference of the neck opening, except at the zipper 70 where such attachment is prohibited by need to retain the functional purpose of the zipper 70 to open and the close the openable/closeable side of the hood 12. At the zipper 70, a first end 96A of the neck flap is selectively foldable into a closed position (as illustrated) that spans over the zipper 70 from one side thereof and connects to a second end 96B of the neck flap situated on an opposing side of the zipper 70, for example by cooperating pieces of hook and loop fabric on an inside of the neck flap's first end 96A and an outside of the neck flap's second end 96B. The first end is 96A is unfoldable from this closed position into an open position revealing the zipper 70 to enable opening and closing thereof. When the zipper 70 is closed, the neck flap 96 can in turn be closed over the zipper 70, as shown in the figure.

As shown in FIG. 14B, the neck flap 96 is foldable upwardly about its hood-attached upper margin into a raised position revealing the lower neck margin of the hood 12 that is otherwise concealed behind the neck flap 96 when in its normal hanging position. This raised position of the neck flap 96 in FIG. 14B enables coupling of an upper body shroud 98 to the exposed lower neck margin of the hood 12 in external relation thereto, which is thus of non-interfering relationship to the neck seal that internally lines the lower neck margin of the hood 12. The upper body shroud 98 is shaped to at least partially cover the shoulders, upper chest, lower rear neck, and upper back of the user, or any subset or subcombination thereof. The shroud may alternatively take the form of a full body suit that makes use of the same flap-covered coupling to the hood 12. An upper neck margin 100 of the upper body shroud 98 that spans around a neck opening thereof may be elasticized to provide self cinching fit thereof around the exposed lower neck margin of the hood 12 when pulled upwardly thereover, or alternatively may be quipped with one of either hook or loop fastener on an interior of the upper body shroud's upper neck margin 100 for mating with a respective one of either loop or hook fastener similarly provided on an exterior of the hood's lower neck margin.

FIG. 14C shows the upper body shroud 98 in coupled relation to the hood 12, with the body shroud's upper neck margin 96 fitted around the lower neck margin of the hood 12 just below the raised neck flap 96, and secured thereto through elastic fit and/or fastened attachment (e.g. by mated hook and loop fasteners). As shown in FIG. 14D, the neck flap 96 is then folded down into its hanging position to once again cover the lower neck margin of the hood 12, and thereby encompass the upper neck margin 100 of the upper body shroud 98 between the hanging neck flap 96 and the hood's lower neck margin. The external coverage of the upper body shroud's upper neck margin 100 by the neck flap 96 of the hood 12, combined with wearing of the upper body shroud 98 externally over the user's clothing, effectively seals the neck opening of the user's clothing, and prevents, or at least reduces the chance of, contaminates gaining entry to the user's clothing.

In donning of the hood 12 and the upper body shroud 98, the shroud 98 is donned first, over the user's head, with the upper neck margin 100 of the upper body shroud 98 initially pulled down to reside at low elevation near the bottom of the user's neck, just above the shoulders. The hood 12 is then donned in the manner already described above, which once completed, and with the zipper 70 thus closed to effect fluid-tight closure of the neck seal around the user's neck, the neck flap 96 of the hood, if not already raised, is lifted up to expose the lower neck margin of the hood. The upper neck margin 100 of the upper body shroud 98 is then pulled up around the lower neck margin 12 of the hood, and fitted securely therearound in coupled relation thereto via the above contemplated elastic fitment or fastened coupling, or some applied cinching action, after which the neck flap 96 is lowered back down into its hanging position, and closed over the zipper 70 if not already, thereby encapsulating the upper neck margin 100 of the coupled body shroud 98 beneath the hanging neck flap 96.

FIG. 15 shows another variant of the respirator 10″, which features the same zipper relocation and neck flap inclusion embodied in the preceding variant 10′ of FIGS. 14A to 14D, but to which there is further added a hood-cinching mechanism 102 by which the hood can be cinched down in size to a more conforming fit to the wearer's head, and any religious head covering that may be worn thereon. The mechanism includes a plurality of elongated cinching members, embodied as a set of cinching cords 104 in the illustrated example, though cinching straps may alternatively be employed in place of such cords 104. The cinching cords 104 are dispersed over a significant surface area of the hood 12 in different positions from one another. Over at least a partial length of each cinching cord 104, the cinching cord runs along the surface of the hood 12 in a discretely different orientation thereon from each, or at least from a subset, of the other cords 104. In the schematically illustrated example, each cinching cord is sheathed, over a majority of its length, within a respective channel 106 formed on the hood, whereby the cord 104 is not openly exposed and does not risk catching or entanglement with anything during donning of the hood and subsequent wearing thereof. The set cinching cords 104 are gathered and bundled together at a congregation point 108 just outside adjacent open ends of the cord channels 106. In the illustrated example, the congregation point 108 resides at a rear upper region of the hood 12 to reside, at or near (e.g. slightly below) the crown of the wearer's head, though the chosen location on the hood 12 for this congregation point 106 may vary, and for example may instead reside at the openable/closeable side of the hood, near the zipper 70.

Each cinching cord 104 is anchored to the hood 12 at least at a terminal end of the cord 104 furthest from the congregation point 108, and optionally may be anchored to the hood at a plurality of discretely spaced anchor points therebetween. The bundled set of cords 104 at the congregation point 108 feed through a cord lock 110 or comparably operable locking device. When the cord lock 110 is released from a locked engagement to the bundled cords 104, the bundled set of cords 104 can be pulled further through cord lock 110, thus pulling the anchored terminal ends of the cords 104 closer toward the cord lock 110, and thereby cinching the hood 12 into a closer fit around the wearer's head, and thus likewise in closer fitting relationship to any religious headwear that the user may be wearing. Return of the cord lock 110 to its locking state, e.g. via user-release of a spring loaded plunger 110A that was previously displaced by the user to release the cord lock from its defaulted locking state, will then re-engage the cord lock 110 back into locked engagement with the bundled set of cords 104, which in their now-tightened state will thus retain this cinched, more form-fitting condition of the hood 12.

In the illustrated example, at the bundled end of the cords 104 situated outwardly beyond the cord lock 110, the cord bundle is shown equipped with a pull fitting 112 to serve as a more grippable actuator or handle by which the bundled cord set can be pulled during this hood-cinching action, whereby one hand is used to release the cord lock 110, and the other to pull on the bundled cords 104 via the pull fitting 112. Alternatively, for example, the cords 104 may be tied into a ball at their bundled ends to form a similar enlargement by which the user can pull on the bundled cords. While the illustrated example shows the cinching cords 104, their respective channels 106, the bundled cord ends, cord lock 110 and pull fitting 112 all situated externally of the hood 12, this overall cinching mechanism may alternative be embodied internally of the hood 12. In the external case of the illustrated embodiment, the hood-cinching operation is performed after closure of the hood 12 and neck seal via the shared zipper 70, whereas in the alternative case of an internal implementation of the cinching mechanism 102, the hood-cinching operation would instead be performed after donning of the mask assembly and head harness, but before closure of the hood 12 and neck seal with the zipper 70, as the open side of the hood would be relied upon to access the internally implemented cinching mechanism.

Since various modifications can be made in my invention as herein above described, and many apparently widely different embodiments of same made, it is intended that all matter contained in the accompanying specification shall be interpreted as illustrative only and not in a limiting sense.

1. A hooded full-face respirator comprising:
a mask assembly comprising:
a shield for covering a face of a wearer at a facial area thereof that includes a nose, mouth and eyes of said wearer;
a face seal spanning along an outer perimeter of the shield and projecting rearwardly therefrom for sealed placement against the face of the wearer in a position surrounding said facial area thereof;
ports and associated valving accompanying the shield and the face seal, and positioned and operable to admit breathable air to the facial area of the wearer and exhaust exhaled gases therefrom;
a wearable hood of fluid-impermeable character and having a face opening in which the mask assembly is received, and around which the wearable hood has a fluid-tight attachment to the mask assembly around a full perimeter of the face-opening, and a neck opening in which a neck of the wearer is accommodated in a worn position of the respirator, and that is bordered by a neck margin of said wearable hood; and
a flexible neck seal comprising flexible impervious material and spanning about the neck opening, said neck seal having an inner wall bordering said neck opening for skin-abutting fluid-tight contact of an inner surface of said inner wall with the neck of the user in said worn position of the respirator; and an outer wall that is connected to the inner wall and situated outwardly of an outer surface thereof, and to which the neck margin of the wearable hood is sealed

2. The respirator of claim 1 wherein the flexible neck seal forms an open-ring around the neck opening, said open ring having gap therein.

3. The respirator of claim 2 wherein the outer wall spans less of angular range around the neck opening that the inner wall, and merges with the inner wall on both sides of the gap at an offset distance therefrom, whereby the neck single has a singular wall structure at said gap.

4. The respirator of claim 2 or 3 comprising a closure mechanism operable between an open position in which the gap in the neck seal is open to enable donning of the respirator, and a closed position closing said gap of the neck seal to achieve fluid-tightness thereof around the wearer's neck in the worn position of the respirator.

5. A hooded full-face respirator comprising:
a mask assembly comprising:
a shield for covering a face of a wearer at a facial area thereof that includes a nose, mouth and eyes of said wearer;
a face seal spanning along an outer perimeter of the shield and projecting rearwardly therefrom for sealed placement against the face of the wearer in a position surrounding said facial area thereof;
ports and associated valving accompanying the shield and the face seal, and positioned and operable to admit breathable air to the facial area of the wearer and exhaust exhaled gases therefrom;
a wearable hood of fluid-impermeable character and having a face opening in which the mask assembly is received, and around which the wearable hood has a fluid-tight attachment to the mask assembly around a full perimeter of the face-opening, and a neck opening in which a neck of the wearer is accommodated in a worn position of the respirator, and that is bordered by a neck margin of said wearable hood; and
a flexible neck seal comprising flexible impervious material and spanning about the neck opening, wherein the flexible neck seal forms an open-ring around the neck opening, said open ring having gap therein; and
a closure mechanism operable between an open position in which the gap in the neck seal is open to enable donning of the respirator, and a closed position closing said gap of the neck seal to achieve fluid-tightness thereof around the wearer's neck in the worn position of the respirator to prevent fluid from entering a resultingly enclosed and sealed headspace inside the hood.

6. The respirator of claim 4 or 5 wherein said closure mechanism comprises a fluid-tight zipper for fluid-tight closure of said gap in the neck seal.

7. The respirator of any one of claims 4 through 6 wherein the wearable hood has an openable/closable side at which the gap in the neck seal also resides, and the closure mechanism is operable to open both the openable/closable side of the hood and the gap of the neck seal in the open position in preparation for donning of the respirator, and close both the openable/closable side of the hood and the gap of the neck seal in the closed position for fluid-tightness in the worn position of the respirator.

8. The respirator of claim 6 wherein the wearable hood has an openable/closable side having a zipper opening therein that is openable and closable by the same fluid-tight zipper as the gap in the neck seal, whereby the open position of the fluid-tight zipper opens both the neck seal and the openable/closeable side of the wearable hood in preparation for donning of the respirator, and the closed position of the fluid-tight zipper closes both the neck seal and the openable/closeable side of the wearable hood for fluid-tightness in the worn position of the respirator.

9. The respirator of claim 7 or 8 wherein the openable/closable side of the wearable hood is a lateral side thereof of non-opposing relation to the face opening of the wearable hood.

10. The respirator of any preceding claim wherein the mask assembly further comprises:
a multi-piece clamp composed of multiple clamping pieces clamping the face seal and the shield together around the perimeter of the shield; and
an endless single-piece ring-shaped base frame that uninterruptedly spans a closed loop path around the multi-piece clamp and the face seal at an outer perimeter of the mask assembly; and
wherein the fluid-tight attachment of the wearable hood to the mask assembly fully and continuously spans an entirety of the base frame's closed loop path around the multi-piece clamp and the face seal.

11. A hooded full-face respirator comprising:
a mask assembly comprising:
a shield for covering a face of a wearer at a facial area thereof that includes a nose, mouth and eyes of said wearer;
a face seal spanning along an outer perimeter of the shield and projecting rearwardly therefrom for sealed placement against the face of the wearer in a position surrounding said facial area thereof;
ports and associated valving accompanying the shield and the face seal, and positioned and operable to admit breathable air to the facial area of the wearer and exhaust exhaled gases therefrom;
a multi-piece clamp composed of multiple clamping pieces clamping the face seal and the shield together around the perimeter of the shield; and
an endless single-piece ring-shaped base frame that uninterruptedly spans a closed loop path around the multi-piece clamp and the face seal at an outer perimeter of the mask assembly; and
a wearable hood of fluid-impermeable character and having a face opening in which the mask assembly is received;
wherein a facial margin of the wearable hood borders and fully surrounds the face opening therein, and said facial margin of the wearable hood is sealed to the single-piece base frame of the mask assembly over a full and continuous span of the base frame's closed loop path around the multi-piece clamp and the face seal.

12. The respirator of any preceding claim wherein the hood comprises an outer neck flap spanning externally around the neck margin hood to accommodate receipt of an upper neck margin of an upper body shroud in a position encapsulated under the outer neck flap of the hood around the neck margin thereof.

13. A hooded full-face respirator comprising:
a mask assembly comprising:
a shield for covering a face of a wearer at a facial area thereof that includes a nose, mouth and eyes of said wearer;
a face seal spanning along an outer perimeter of the shield and projecting rearwardly therefrom for sealed placement against the face of the wearer in a position surrounding said facial area thereof;
ports and associated valving accompanying the shield and the face seal, and positioned and operable to admit breathable air to the facial area of the wearer and exhaust exhaled gases therefrom;
a wearable hood of fluid-impermeable character and having a face opening in which the mask assembly is received, and around which the wearable hood has a fluid-tight attachment to the mask assembly around a full perimeter of the face-opening, and a neck opening in which a neck of the wearer is accommodated in a worn position of the respirator, and that is bordered by a neck margin of said wearable hood; and
a flexible neck seal comprising flexible impervious material and spanning about the neck opening inside the neck margin of the hood;
wherein the hood comprises an outer neck flap spanning externally around the neck margin of the hood for receipt of an upper neck margin of an upper body shroud in a position encapsulated under the outer neck flap of the hood and spanning around the neck margin thereof.

14. The respirator of any preceding claim wherein the hood comprises a set of cinching members that are distributed over a surface area of the hood, and are bundled together at a congregation point from which the cinching members are collectively pullable to cinch the hood into a cinched state of more form-fitting character when worn on a head of the wearer.

15. The respirator of any one of claims 1 to 13 wherein the hood comprises a set of cinching members that are distributed over a surface area of the hood, and are each sheathed in a respective channel, and are pullable to cinch the hood into a cinched state of more form-fitting character when worn on a head of the wearer.

16. A hooded full-face respirator comprising:
a mask assembly comprising:
a shield for covering a face of a wearer at a facial area thereof that includes a nose, mouth and eyes of said wearer;
a face seal spanning along an outer perimeter of the shield and projecting rearwardly therefrom for sealed placement against the face of the wearer in a position surrounding said facial area thereof;
ports and associated valving accompanying the shield and the face seal, and positioned and operable to admit breathable air to the facial area of the wearer and exhaust exhaled gases therefrom;
a wearable hood of fluid-impermeable character and having a face opening in which the mask assembly is received, and around which the wearable hood has a fluid-tight attachment to the mask assembly around a full perimeter of the face-opening, and a neck opening in which a neck of the wearer is accommodated in a worn position of the respirator, and that is bordered by a neck margin of said wearable hood; and
a flexible neck seal comprising flexible impervious material and spanning about the neck opening inside the neck margin of the hood;
wherein the hood comprises a set of cinching members that are distributed over a surface area of the hood and are pullable to cinch the hood into a cinched state of more form-fitting character when worn on a head of the wearer.

17. The respirator of claim 16 wherein said cinching members are bundled together at a congregation point from which the cinching members are collectively pullable to cinch the hood into said cinched state.

18. The respirator of claim 16 or 17 wherein said cinching members are each sheathed in a respective channel on the hood.

19. The respirator of any preceding claim comprising a head harness coupled to the mask assembly in a position spanning rearwardly therefrom to embrace posteriorly about a head of the wearer to secure the shield anteriorly of the face of the wearer, said head harness comprising a flexible upper component for connection to the mask assembly at upper securement points thereon, and a pair of flexible lower components for connection to the mask assembly at lower securement points thereon, wherein said flexible upper component includes a widened top band of greater width than each of said flexible lower components for draped donning of said widened top band over the head of the wearer or a religious head covering worn thereon.

20. A full-face respirator comprising:
a mask assembly comprising:
a shield for covering a face of a wearer at a facial area thereof that includes a nose, mouth and eyes of said wearer;
a face seal spanning along an outer perimeter of the shield and projecting rearwardly therefrom for sealed placement against the face of the wearer in a position surrounding said facial area thereof;
ports and associated valving accompanying the shield and the face seal, and positioned and operable to admit breathable air to the facial area of the wearer and exhaust exhaled gases therefrom; and
a head harness coupled to the mask assembly in a position spanning rearwardly therefrom to embrace posteriorly about a head of the wearer to secure the shield anteriorly of the face of the wearer;
wherein said head harness comprises a flexible upper component for connection to the mask assembly at upper securement points thereon, and a pair of flexible lower components for connection to the mask assembly at lower securement points thereon, wherein said flexible upper component includes a widened top band of greater width than each of said flexible lower components for draped donning of said widened top band over the head of the wearer or a religious head covering worn thereon.

21. The respirator of claim 19 or 20 wherein the flexible upper component of the head harness further comprises a pair of top straps extending forwardly from a front end of the widened top band to make said connection to the mask assembly at said upper securement points thereon, and said widened top strap is also of greater width than said top straps.

22. A method for donning of a full-face respirator by a wearer, said method comprising:
(a) in possession of a full-face respirator that comprises a wearable hood with a face opening and a neck opening, a non-endless neck seal attached to the wearable hood around the neck opening therein and having an openable/closable gap, a face mask assembly received in a face opening of the wearable hood and sealed thereto, and a face seal and a head harness attached to said face shield, donning the face shield, the head harness and the wearable hood while the openable/closable gap of the neck seal is open;
(b) once the face shield, the head harness and the wearable hood have been donned to envelop the wearer's head and the head harness within the wearable hood, closing the openable/closable gap of the neck seal to fully close said neck seal around a neck of the wearer.

23. The method of claim 22 wherein the wearable hood also comprises an openable/closable side, step (a) comprises first donning the face shield and head harness while the openable/closable side of the wearable hood and the openable/closable gap of the neck seal are both open with the wearable hood drawn forwardly out of the way of the head harness, and, once the face shield and head harness are cooperatively holding the face seal snug against a face of the wearer, then pulling the hood posteriorly into enveloping relationship around the head harness and the wearer's head, and step (b) comprises closing both the openable/closable side of the wearable hood and the openable/closable gap of the neck seal.

24. The method of claim 23 wherein step (b) comprises using a shared closure mechanism to close both the openable/closable side of the wearable hood and the openable/closable gap of the neck seal.

25. The method of claim 24 wherein said shared closure mechanism comprises a fluid-tight zipper.

26. The method of any one of claims 22 to 25 wherein said wearer is a wearer of religious headwear, and pulling the hood posteriorly in step (a) comprises pulling the hood posteriorly over the religious headwear of the wearer into enveloping relationship therearound.

27. The method of claim 26 comprising cinching the hood into a cinched state of better conformance to said religious headwear using a built-in cinching mechanism on said hood.

28. The method of claim 27 wherein said built-in cinching mechanism on said hood is located on an interior of said hood, and said hood is cinched into said cinched state prior to closure of the neck seal.

29. The method of claim 27 wherein said built-in cinching mechanism on said hood is located on an exterior of said hood, and said hood is cinched into said cinched state after closure of the neck seal.

30. The method of any one of claims 22 to 29 wherein said wearer has a beard, and step (b) comprises closing the openable/closable gap of the neck seal at an elevation below a neckline of said beard.

31. A method of donning the full-face respirator of claim 20 or 21 by a wearer, wherein said wearer is a wearer of religious headwear, and the method comprises draping said widened top band of the head harness over said religious headwear to distribute any loading of the head harness evenly across a large surface area of said religious headwear in non-disruptive fashion thereto.

32. The respirator of any one of claims 1 to 18 comprising a head harness coupled to the mask assembly in a position spanning rearwardly therefrom to embrace posteriorly about a head of the wearer to secure the shield anteriorly of the face of the wearer, and a tensioning mechanism at a rear portion of the head harness situated distally of the mask assembly and operable to tension one or more tensionable components of the head harness to pull the face seal snug against the face of the wearer.

33. A full-face respirator comprising:
a mask assembly comprising:
a shield for covering a face of a wearer at a facial area thereof that includes a nose, mouth and eyes said wearer;
a face seal spanning along an outer perimeter of the shield and projecting rearwardly therefrom for sealed placement against the face of the wearer in a position surrounding said facial area thereof;
ports and associated valving accompanying the shield and the face seal, and positioned and operable to admit breathable air to the facial area of the wearer and exhaust exhaled gases therefrom;
a head harness coupled to the mask assembly in a position spanning rearwardly therefrom to embrace posteriorly about a head of the wearer to secure the shield anteriorly of the face of the wearer; and
a tensioning mechanism at area portion of the head harness situated distally of the mask assembly and operable to tension one or more tensionable components of the head harness to pull the face seal snug against the face of the wearer.

34. The respirator of claim 32 or 33 wherein said one or more tensionable components comprises a pair of tensionable lower components spanning from the tensioning mechanism to lower securement points on opposing sides of a lower half of the mask assembly so as to reside on opposing sides of the wearer's head in the worn position of the respirator, and the head harness further comprises an upper component spanning from the tensioning mechanism to an upper half of the mask assembly so as to overlie the wearer's head in the worn position of the respirator.

35. The respirator of claim 34 wherein, of the upper and lower components of the head harness, the tensioning mechanism is configured to tension only said lower components.

36. The respirator of claim 34 or 35 wherein at least part of the upper component comprises of the head harness is wider than each of said lower components.

37. The respirator of any one of claims 32 to 36 wherein at least a subset of the tensionable members comprise cords.

38. A method for donning of a full-face respirator by a wearer, said method comprising:
(a) in possession of a full-face respirator that comprises a face shield with an attached face seal and head harness, placing the face seal against a face of the wearer while placing a rear portion of the head harness behind a head of the wearer in opposing relation to the face shield; and
(b) using a tensioning mechanism operably coupled to one or more tensionable components of the head harness, tensioning said one or more tensionable components of the head harness to pull the face seal snug against the face of the wearer.

39. The method of claim 38 wherein the tensioning mechanism resides at a rear portion of the head harness.

40. The method of claim 38 or 39 wherein said one or more tensionable components comprises a pair of tensionable lower components spanning from the tensioning mechanism to lower securement points on opposing sides of a lower half of the mask assembly so as to reside on opposing sides of the wearer's head in the worn position of the respirator, and the head harness further comprises an upper component spanning from the tensioning mechanism to an upper securement point on an upper half of the mask assembly so as to overlie the wearer's head in the worn position of the respirator.

41. The method of claim 40 wherein, of the upper and lower components of the head harness, the tensioning mechanism is configured to tension only said lower components.

42. The method of any one of claims 38 to 41 wherein the full-face respirator further comprises a wearable hood with a face opening in which the mask assembly is received in a manner sealed to the hood around the face opening therein, steps (a) and (b) are performed with the wearable hood drawn forwardly out of the way of the head harness and tensioning mechanism, and the method further comprises (c) pulling the hood posteriorly into enveloping relationship around the head harness and the wearer's head.

43. The method of claim 42 wherein the wearable hood also comprises an openable/closable side that is openable and closable by a zipper, steps (a) through (c) are performed with the zipper open, after which the method further comprises (d) closing the zipper.

44. The method of claim 43 wherein said openable/closeable side of the wearable hood is a lateral side thereof of non-opposing relationship to the face shield.

45. The method of claim 43 or 44 wherein the full-face respirator further comprises a non-endless neck seal attached to the wearable hood at a neck margin thereof bordering a neck opening therein, and step (d) comprises using the zipper to close both a gap in the neck seal and the openable/closable side of the wearable hood, whereby a singular action of closing said zipper is operable to both close-off an interior space of the hood and secure said neck seal in fluid-tight relation around a neck of the wearer.

46. The method of any one of claims 38 to 44 wherein said wearer is a wearer of religious headwear, and step (a) comprises draping an upper portion of head harness posteriorly over the head of the wearer into a position lain overtop of said religious headwear.

47. The method of claim 46 wherein said wearer also has a beard, the full-face respirator further comprises a non-endless neck seal attached to the wearable hood at a neck margin thereof bordering a neck opening therein, and the method further comprise closing a gap in said non-endless neck seal to fully close said neck seal around a neck of the wearer at an elevation below a neckline of said beard.
